(19) United States
(12) Patent Application Publication
(10) Pub. No.: US 2003/0089141 A1
(43) Pub. Date: May 15, 2003

(54) Lock and tool accessory

(76) Inventors: Joseph H. Edwards, Salt Lake City, UT (US); Robert Murphy, San Diego, CA (US)

Correspondence Address: Thomas J. Rossa, Holme Roberts & Owen LLP, Suite 1100, 111 East Broadway, Salt Lake City, UT, 84111-5233, US

(21) Appl. No.: 10/036,269

(22) Filed: Nov. 9, 2001

(51) Int. Cl. E05B 73/00

(52) U.S. Cl. 70/18; 70/30; 70/58

(57) ABSTRACT

A lock and tool accessory includes a housing that has a first end and a second end and that is sized for gripping by the hand of a user. A combination lock mechanism and a cable lock extension are connected to or positioned within the housing. The cable lock extension is positionable about any one or more of a ski, a pair of skis, a snow-board, a ski-like item or a snow-board-like item and is securable to the housing by a lock mechanism. A plurality of tools are rotatably connected to a shaft positioned within a recess formed in the housing. A removable tool is removably secured within a second recess formed in the housing. The tools are selected and sized for making adjustments to any one or more of the accessories found on a ski, a pair of skis, a snow-board, a ski-like item or a snow-board-like item or to a component mounted thereon.

### BACKGROUND OF THE INVENTION

1. Field of the Invention

The present invention relates to a hand-held lock and tool accessory and, more particularly, to a hand-held lock and tool accessory that is useful both for locking, or rendering unuseable, ski-like and snow-board-like items and for performing adjustments to components attached to ski-like and snow-board-like items.

2. Description of the Related Art

Portable lock devices are known. For example, U.S. Pat. Nos. 5,832,752 (Zeller) and 5,156,028 (Jiang) disclose portable cable lock devices that have a retractable cable wound on a spool disposed within a housing. To operate the devices, a cable is withdrawn from the spool and threaded about an unsecured item together with a restraining structure. The free end of the cable is then locked to the housing. The No-Jack™ recoiling pocket lock, available from Seirus Innovative Accessories, Inc., of Poway, Calif., is a further example of a portable cable lock device.

Portable tool devices are also known. For example, U.S. Pat. No. 4,744,272 (Leatherman) discloses a portable tool device that incorporates multiple tools that may be separately deployed for use. Some “Swiss Army” knives also feature multiple tools that are deployable from a recess for use.

For skis, snow-boards, snowshoes and the like, there may be attachments like bindings that allow for adjustment and which are held in place by screws, bolts or the like. The need for adjustment may arise for several reasons. For instance, the cold outdoor environment may allow an otherwise secure fastener to loosen, leading to a need for tightening while in use. Portable tools like those mentioned above are not particularly well suited for such use because they are not necessarily sized for such use. Moreover, they do not allow for sufficient leverage, particularly when used with gloves in what can be a very cold and harsh environment. At the same time, users have a need from time to time to secure their skis, snow-board, show-shoes or the like from theft when, for example, the user leaves the skis, snow-board, snowshoes or the like unattended. Carrying multiple tools and locks is not desirable because there is limited pocket space. Also single open tools pose a personal risk to the user.

### SUMMARY OF THE INVENTION

A lock and tool accessory is useful for securing or rendering unuseable any one or more of a ski, a pair of skis, a snow-board, a ski-like item or a snow-board-like item and for making adjustments to the same or to components mounted thereon. The lock and tool accessory includes a housing that has a first end and a second end, and that is sized for gripping by the hand of a user.

The lock and tool accessory includes a lock mechanism and a lock extension connected to or positioned in the housing. The lock extension is positionable about any one or more of a ski, a pair of skis, a snow-board, a ski-like item or a snow-board-like item and is securable to the housing by the lock mechanism. A plurality of tools is also connected to, or formed within or on, the housing. The tools are selected and sized for making adjustments to said any one or more of the accessories found on a ski, a pair of skis, a snow-board, a ski-like item or a snow-board-like item or to a component mounted thereon.

In a preferred embodiment, a plurality of rotatable tools such as, for example, a flat-head screwdriver, a Phillips-head screwdriver and a hex-head driver, each with a head sized to cooperatively fit with screws or other components found on snow-boards, skis and the like, are rotatably disposed on a shaft that is positioned within a first recess formed in the housing. The tools are rotatable between a first position for storage within the recess and a second position for operation when rotated out of the recess. In addition, a removable tool—for example, an open-end wrench—is removably disposed in a second recess in the housing.

The accessory includes a spool rotatably disposed on a shaft within the housing and biased, for example, by a volute spring mounted between the spool and the shaft. An extendable cable is wound on the spool with the proximal end of the cable being secured to the spool. The distal end of the cable extends from the housing for withdrawal and positioning about any one or more of a ski, a pair of skis, a snow-board, a ski-like item or a snow-board-like item. After the cable is positioned about any one or more of the skis, snow-board or the like, the distal end is then secured back to the housing by a lock mechanism, which is preferably a combination lock mechanism disposed within the housing.

Desirably, a spool locking member releaseably engages the spool through a ratchet wheel mounted coaxially to the spool. The spool locking member normally engages the ratchet wheel to inhibit rotation of the spool in either direction. The spool locking member is disengaged from the ratchet wheel by operation of a spool release button that protrudes through the housing and is in mechanical association with the spool locking member.

Upon disengagement of the spool locking member, the spool is freely rotatable in either a cable withdrawal direction or a cable retract direction. As the cable is withdrawn from the housing, the volute spring is wound to bias the spool to rotate in the cable retract direction. Excess cable may thereby be retrieved into the housing by automatic rotation of the spool in the cable retract direction upon disengagement of the spool lock member.

In preferred arrangements, the housing secures both ends of the cable lock extension for the locking function and provides a handle with which to manipulate the tools for the adjusting function. The housing, therefore, is constructed of plastic or metal materials of sufficient strength in order to withstand the stresses placed on it while a user manipulates a component (e.g., adjusts a screw) or while a would-be-thief tries to break apart the housing in order to steal the ski-like or snow-board-like item being secured thereby. The housing is also shaped with finger recesses on a first side of the housing and with serrations on a second side for effective gripping by the user and for achieving a relatively high magnitude of torque and force at the workpiece of the tool.

Alternative embodiments include, for example, slidable tools or shaped tools incorporated into the housing to provide an additional selection of tools or to act as substitutes for the rotatable tools and the removable tools described above. Further, a key and tumbler lock mechanism may be substituted for the preferred combination lock mechanism, and a rigid lock extension may be substituted for the extendable cable.

### BRIEF DESCRIPTION OF THE DRAWINGS

In the drawings which illustrate preferred embodiments of carrying out the invention:

FIG. 1 is a perspective view of a preferred embodiment of the present invention;

FIG. 2A is a depiction of a preferred embodiment of the present invention in use rendering an item unuseable;

FIG. 2B is a depiction of a preferred embodiment of the present invention in use securing an item to a restraining structure;

FIG. 3A is a perspective view of an embodiment of the present invention in use;

FIG. 3B is a perspective view of an embodiment of the present invention in use;

FIG. 4 is an exploded view of a preferred embodiment of the present invention;

FIG. 5 is a cut-away view of the portion taken along line 5-5 in FIG. 1;

FIG. 6 is a side view of an alternate embodiment of the tool means of the present invention;

FIG. 7 is a cut-away view of the portion taken along line 7-7 in FIG. 6;

FIG. 8 is a partial side view of another alternate embodiment of the present invention;

FIG. 9 is a partial side view of another alternate embodiment of the present invention;

FIG. 10 is a side view of a slidable tool of an alternate embodiment;

FIG. 11 is a partial side view of another alternate embodiment of the tool means of the present invention;

FIG. 12 is a partial side view of another alternate embodiment of the tool means of the present invention;

FIG. 13 is a partial three-dimensional view of the present invention with a retaining clip;

FIG. 14 is a side view of an alternate embodiment of the cable retract means of the present invention.

### DETAILED DESCRIPTION

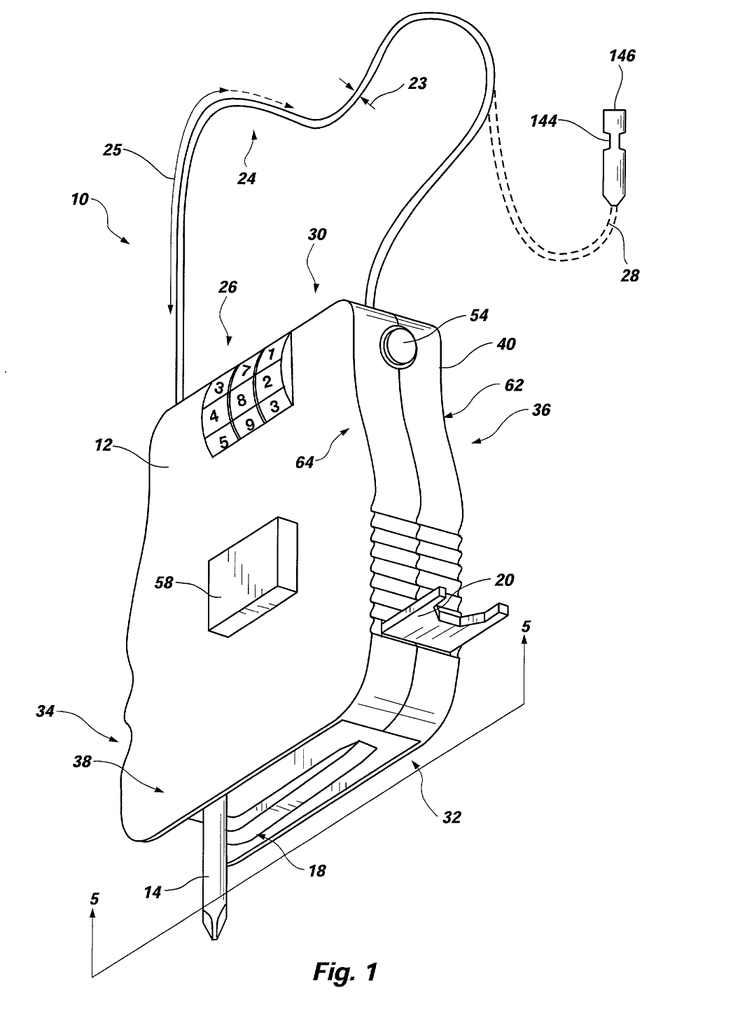

Referring to FIG. 1, a preferred embodiment of the lock and tool accessory 10 includes a housing 12, a combination lock mechanism 26 with an extendable cable 24, a plurality of rotatable tools 14 and a removable tool 20.

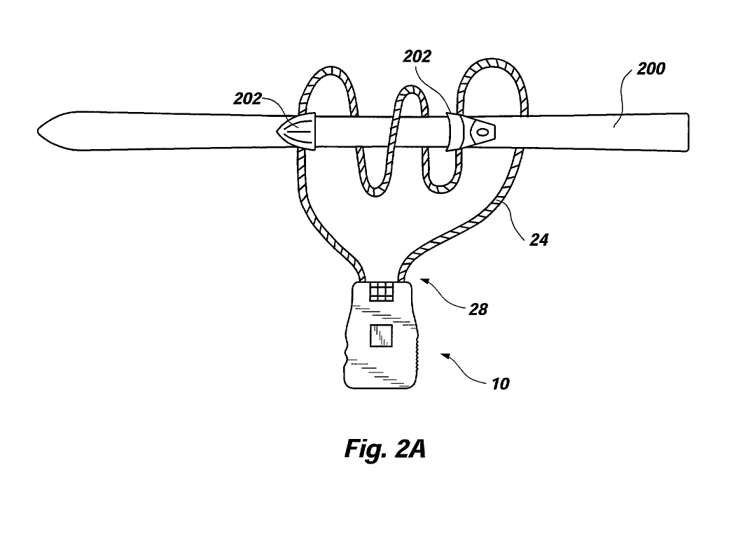

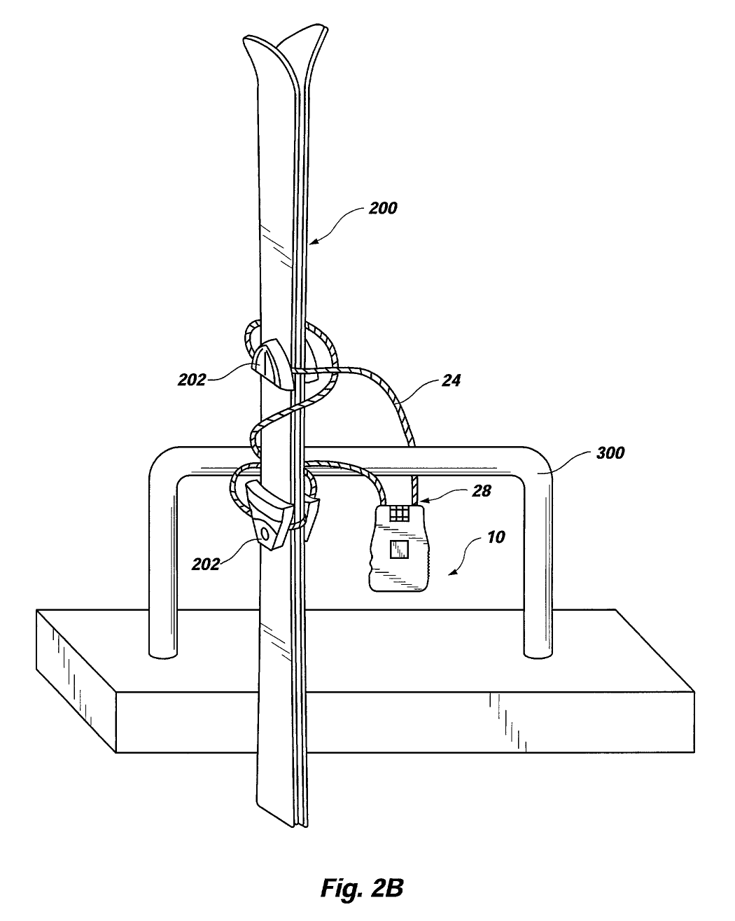

Referring further to FIG. 1 and to FIGS. 2A and 2B, the extendable cable 24 is sized in length 25 so that it may be extended for positioning about any one or more of a ski, a pair of skis, a snow-board, snow shoes, a ski-like item or a snow-board-like item (hereinafter referred to as “lockable items”). The cable 24 is preferably substantially circular in cross section and sized in diameter 23 to be of sufficient strength and size to be unbreakable by pulling apart, by bending or the like and, at the same time, made of a material that is not typically severable—that is, a large cable cutter would be required to sever cable 24.

Once cable 24 is positioned about any one or more of such items, the distal end 28 of extendable cable 24 is secured back to housing 12. With the extendable cable 24 being positioned about any one or more of the lockable items and secured to the housing 12, the lockable items may be rendered unuseable as, for example, would be a ski 200 when the cable is securely positioned about the base of the ski, as shown in FIG. 2A. Alternatively, the extendable 24 cable may be positioned about a restraining structure 300 (e.g., a tree, rack, bar, post, automobile bumper, railing and so on) together with any one or more of the lockable items, as shown in FIG. 2B.

It will be appreciated that the phrase “a ski, a pair of skis, a snow-board, a ski-like item or a snow-board-like item,” or “lockable items” as used herein, is intended to include not only skis and snow-boards, but auxiliary equipment as well, such as boots, bags, packs, and poles. Thus, any reference to a specific use, such as to locking ski 200 as illustrated in FIGS. 2A and 2B, should not be construed to include only a ski, but other such items as a skier may desire. It will also be appreciated that although the present invention is directed toward use with a ski, a pair of skis, a snow-board, a ski-like item or a snow-board-like item, the invention may be used to secure items in general that are not ski or snow-board related. For example, the accessory could be used to secure a bicycle or a skateboard to a restraining structure. The invention will prove most useful, however, when the item being secured or rendered unuseable lends itself to requiring periodic adjustments.

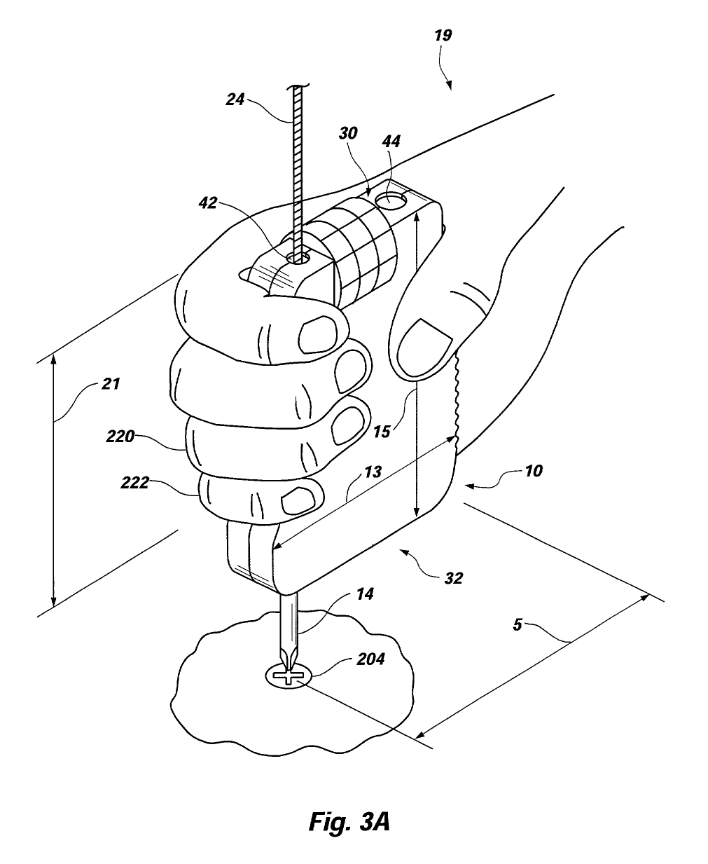

Referring to FIGS. 3A and 3B, the lock and tool accessory 10 is shown in use for performing an adjustment to a component such as screw 204 of a ski, a pair of skis, a snow-board, a ski-like item or a snow-board-like item. It should be apparent that the embodiments shown in FIGS. 3A and 3B facilitate application of torque to screw 204 of a greater magnitude than the torque obtainable using a conventional screwdriver. That is, housing 12 has a width 13 and a height 15 to provide a relatively greater moment arm 5 between the axis of rotation 17 about screw 204 and the resultant point of application of the force being applied to the housing by the hand of a user.

The width 13 and the height 15 are selected so that the housing 12 readily fits into, or is graspable by, the hand 19 of a user. Thus the width 13 in FIGS. 3A and 3B is selected to allow the fingers and thumb of a user to easily grip the housing 12 and rotate or manipulate the same. Similarly, the height 15 is selected so that the housing 12 can extend through length 21 of the palm of the hand and extend outside of the palm area so that the tool, e.g., tool 14, can engage a work item such as screw 204. A housing having a width 13 of about two inches to about four inches, and preferably about three inches, has been found suitable for use. Similarly, height 15 is selected to be from about four inches to about six inches and, preferably, is about five inches.

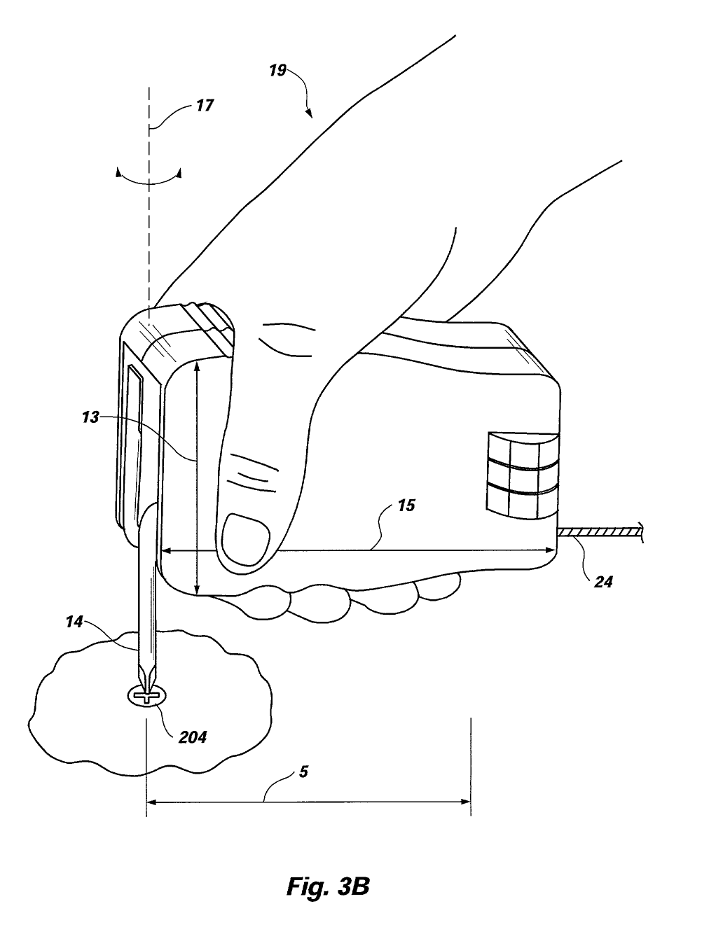

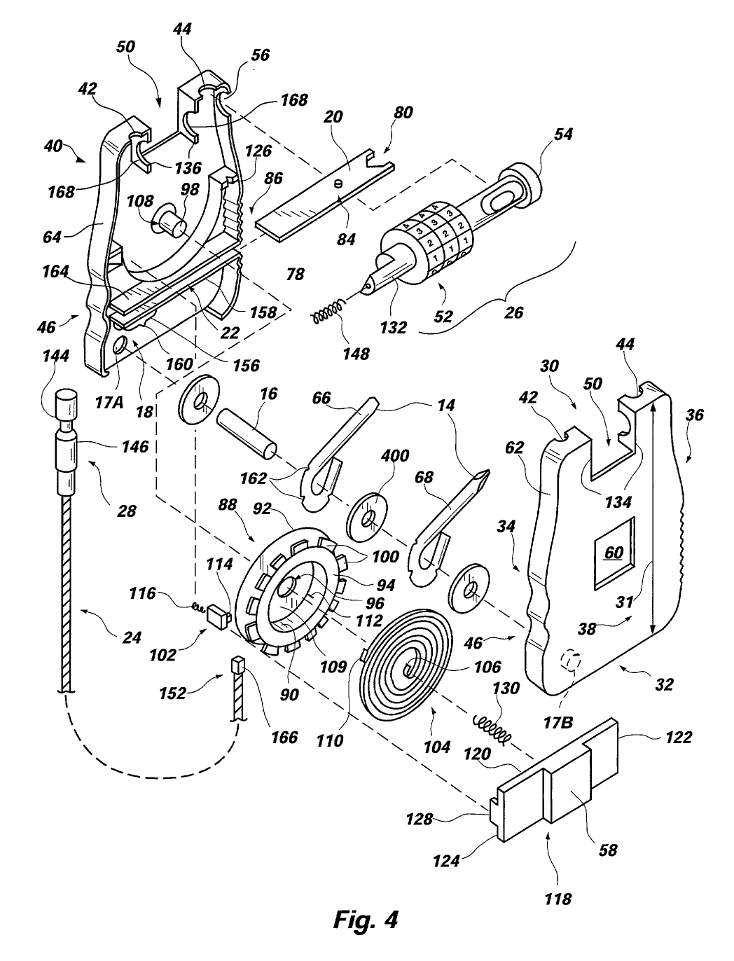

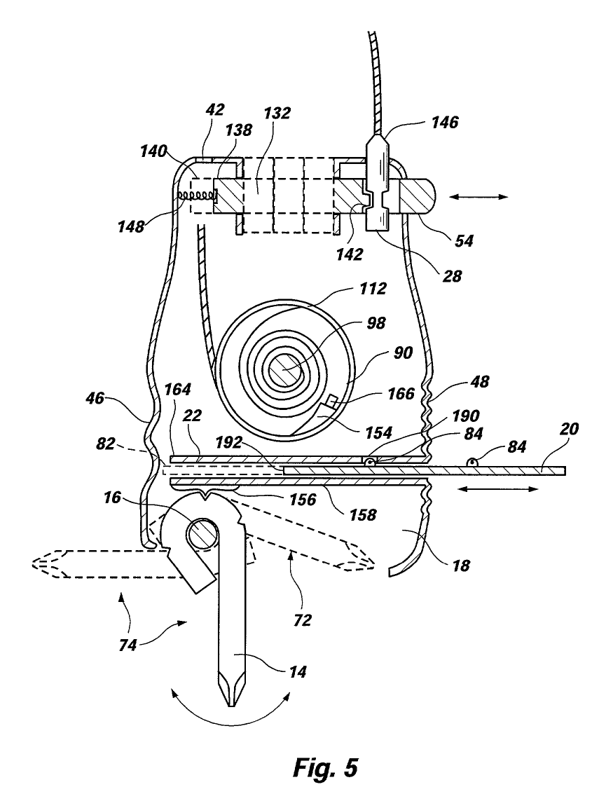

Referring now to FIGS. 4 and 5, the housing 12 is shown having a first end 30 and a second end 32, separated by a distance 31 sufficient to enable gripping of the housing 12 by the hand of a user as discussed hereinbefore. First sidewall 34 and second sidewall 36 extend from first end 30 to second end 32. First surface 38 and second surface 40 extend between first end 30 and second end 32, and between first sidewall 34 and second sidewall 36. First end 30 has a first cable opening 42 and a second cable opening 44. Second end 32 has a recess 18 formed proximate thereto to accept a plurality of rotatable tools 14 rotatably mounted on a shaft 16. First sidewall 34 is contoured 46 to accept at least two fingers of the hand of a user, while second sidewall 36 is serrated 48 on a portion thereof for improved gripping.

First surface 38, second surface 40, and first end 30 each have cut-out portions to form an opening 50 through which dial wheels 52 of combination lock mechanism 26 protrude or otherwise become accessible for operation. Cable lock release button 54 protrudes through hole 56 in second sidewall 36. Cable lock release button 54 operates between a first position in which distal end 28 of cable 24 is securable to axial rod 132 and a second position in which distal end 28 of cable 24 is releaseable from axial rod 132. Similarly, cable retract button 58 protrudes through hole 60 in first surface 38. Cable retract button 58 operates between a first position in which cable 24 is prevented from being retracted into or withdrawn from housing 12 and a second position in which cable 24 is freely retracted into or withdrawn from housing 12.

To simplify construction and assembly of housing 12, first and second ends 30 and 32, first and second sidewalls 34 and 36, and first and second surfaces 38 and 40 may be integrally formed into first and second housing portions 62 and 64, respectively, as shown in FIGS. 1 and 4. First and second housing portions 62 and 64 are preferably made of a durable plastic (e.g., polystyrene) and formed to mate or marry together in a conventional fashion.

With further reference to FIGS. 4 and 5, two rotatable tools 14 are disposed within housing 12 (although more tools could be employed as shown elsewhere herein). Specifically, flat-head screwdriver 66 and Phillips-head screwdriver 68 are rotatably mounted on shaft 16 which is disposed within recess 18 of housing 12. Shaft 16 is secured in place using mount collars 17A and 17B formed on first and second housing portions 62 and 64 respectively. Alternatively, shaft 16 may take the form of a hex-head bolt, for example, which may be secured in place by inserting the bolt through hole portions substituting for mount collars 17A and 17B and by tightening a nut onto the threaded portion of the bolt. This alternative arrangement will require housing portions 62 and 64 to have recesses formed therein for engagement with the circular head of the bolt and the hexagonal-type geometry of the nut. Different types, shapes and sizes of rotatable tools 14 may be employed with the present invention, depending on the intended use. Accordingly, the scope of the present invention contemplates the inclusion of various other implements, for example, a saw, a knife blade, a file, a scissors, an awl, and a corkscrew, as well as screwdriver heads and wrench heads of different dimension or the like.

In the disclosed embodiment, tools 14 are stored at first position 72 (shown in phantom in FIG. 5) in recess 18. Each of tools 14 is rotatable on shaft 16 out of first position 72 to second position 74 (shown alternatively in phantom and in solid in FIG. 5), whereby any one of said tools 14 may be positioned for manipulating a component, e.g., a binding 202 or screw 204. Friction discs 400 are positionable between rotatable tools 14 to aid in securing rotatable tools 14 in either first position 72 or second position 74. Retaining clip 156 may also be used, alternatively or in conjunction with friction discs 400, to secure rotatable tools 14 in either first position 72 or second position 74. Retaining clip 156 may be fastened proximate lower member 158 of slot recess 22. Retaining clip 156 has bump portion 160 extending outwardly for engagement with groove portions 162 on each of rotatable tools 14. Retaining clip 156 is selected to have sufficient stiffness to secure rotatable tools 14, individually, in either first position 72 or second position 74, independent of the position of the other of rotatable tools 14.

Each of rotatable tools 14 may be rotated from first position 72 (shown in phantom) to second position 74, or vice versa, by applying a rotational force to the tool sufficient to overcome the frictional resistance of friction discs 400 and/or the stiffness of retaining clip 156. For example, the user may use his or her fingers to rotate any one or more of tools 14 from first position 72 to second position 74. The tools are preferably stored entirely within recess 18 to reduce the risk of engaging clothing or otherwise being a protrusion and the risk of injury in the event the user falls. Once rotatable tool 14 is in second position 74, the lock and tool accessory 10 may be used for manipulating a component as shown in FIGS. 3A and 3B. It should be understood that second position 74 may assume either of the positions illustrated in FIG. 5 (one of second position 74 is illustrated in phantom), or an intermediate position there between.

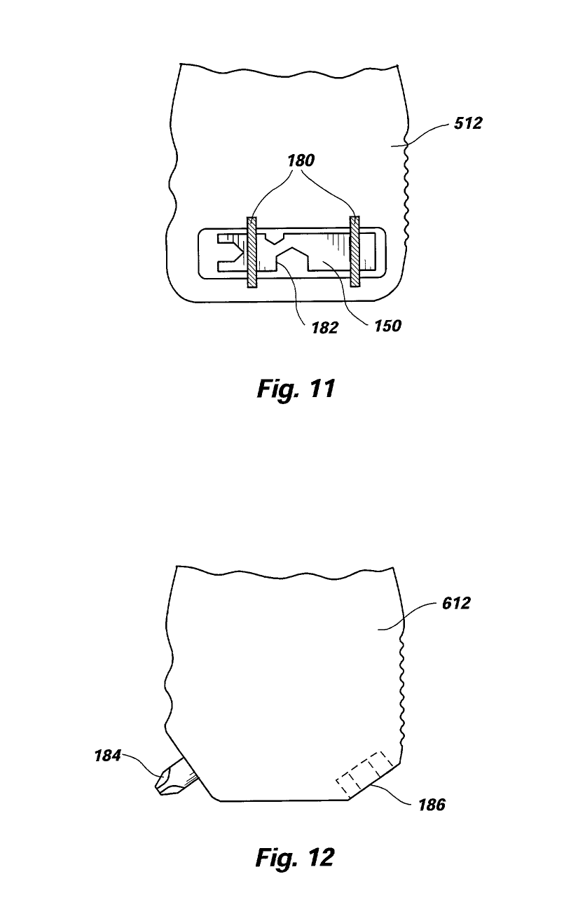

Further referencing FIGS. 4 and 5, removable tool 20 is removably disposed in slot recess 22 which has an opening 78 formed in the second sidewall 36. A single removable tool 20, for example, a wrench 80 of the open-ended type is shown. Different types, shapes and sizes of removable tool 20 may be employed with the present invention, depending on the use contemplated. For example, a single removable tool may contain multiple sizes of wrench openings, as illustrated by wrench 150 in FIG. 11. Alternatively, removable tool 20 may take the form of a screwdriver or the form of any of the tools previously discussed with regard to rotatable tools 14. Further, multiple removable tools may be stored in a recess 22 of sufficient dimension.

In the embodiment as disclosed, tool 20 is held at first position 82 (shown in phantom) in slot recess 22 by means of securing tab 84 which may be formed integral to tool 20 or simply fastened thereon. Alternatively, securing tab 84 may be disposed on either lower member 158 or upper member 164 of slot recess 22, or by use of retaining clip 166 disposed proximate opening 78, as shown in FIG. 13. A preferred embodiment of the invention would include positioning securing tab 84 to engage a hole 190 disposed through either lower member 158 or upper member 164 of slot recess 22. Such an arrangement would permit securing removable tool 20 in second position 192 so that housing 12 may be used as a handle.

Removable tool 20 may be moved from first position 82 to second position 192 by knocking second sidewall 36 against a solid surface, thereby causing tool 20 to partially protrude from slot recess 22. Positioning of tool 20 into second position 192, or complete removal of tool 20, may then be accomplished by grabbing the protruding end of tool 20 and withdrawing the same from slot recess 22, either partially or completely. Replacement of tool 20 into slot recess 22 may be accomplished by placing tail end 86 of tool 20 into slot recess opening 78 and inserting tool 20 until it becomes completely disposed within housing 12.

Further referencing FIGS. 4 and 5, cable lock extension 24 is used to secure, or render unuseable, a ski, a pair of skis, a snow-board, a ski-like item or a snow-board-like item. Cable lock extension 24 has proximal end 152 for securing to housing 12, and distal end 28 for threading about said a ski, a pair of skis, a snow-board, a ski-like item or a snow-board-like item prior to being itself secured to housing 12. Proximal end 152 is threaded through first opening 42 and secured to spool 88 through securing means, such as through socket element 166 abutting socket receiving member 154. Distal end 28, on the other hand, is secured to housing 12 by means of combination lock mechanism 26, as explained further hereafter.

Cable lock extension 24 is wound on spool 88 when retracted inside housing 12. Spool 88 comprises spool hub 90 coaxially mounted between back disk 92 and front disk 94. Axial sleeve 96 is positioned coaxial to spool hub 90 and receives spool mount shaft 98 for axial rotation thereon. Volute spring 104 is disposed in spool opening 109 between spool hub 90 and axial sleeve 96. Center end 106 of volute spring 104 is received in retaining slot 108 formed in spool mount shaft 98. Outer end 110 of volute spring 104 is received in retaining slot 112 of spool hub 90. Volute spring 104 is wound or tightened when cable lock extension 24 is withdrawn from housing 12, thereby biasing spool 88 to automatically re-wind, or rotate in the opposite direction from the direction of withdrawal, and to retract cable lock extension 24 into housing 12.

Withdrawal of cable lock extension 24 from housing 12, and retraction therein, is dependent on rotation of spool 88. Rotation of spool 88 is controlled through spool lock element 102, which is slidably disposed proximate first sidewall 34 and spool 88. Spool lock element 102 has engagement tab 114 for locking engagement with ratchet teeth 100, and is biased by spring means 116 to cause engagement tab 114 to normally engage ratchet teeth 100. When engagement tab 114 is engaged with ratchet teeth 100, spool 88 is prevented from rotating, thereby preventing withdrawal of cable lock extension 24 from within housing 12. On the other hand, when engagement tab 114 is disengaged from ratchet teeth 100, spool 88 is free to rotate, thereby allowing cable lock extension 24 to be withdrawn and secured about ski-like or snow-board-like item 200, or retracted into housing 12.

Engagement of spool lock element 102 is controlled through cable retract means 118. Cable retract means 118 comprises cable retract lever 120, which includes first end 122, second end 124 and cable retract button 58. First end 122 of cable retract lever 120 is pivotally mounted to housing 12 through groove 126 proximate second sidewall 36. In the preferred embodiment, a ridge integral to first end 122 sits in groove 126, providing a hinge means for cable retract lever 120 to pivot about. Second end 124 of cable retract lever 120 makes direct contact with spool lock element 102 via tab 128. Spring means 130 is disposed between spool mount shaft 98 and cable retract lever 120 and biases cable retract lever 120 against first surface 38, causing cable retract button 58 to protrude through hole 60. Depressing cable retract button 58 forces cable retract lever 120 to pivot about groove 126, thereby causing tab 128 to push against spool lock element 102 and force engagement tab 114 out of engagement with ratchet teeth 100. Cable lock extension 24 may thus be withdrawn from housing 12, or retracted therein, when cable retract button 58 is depressed into housing 12.

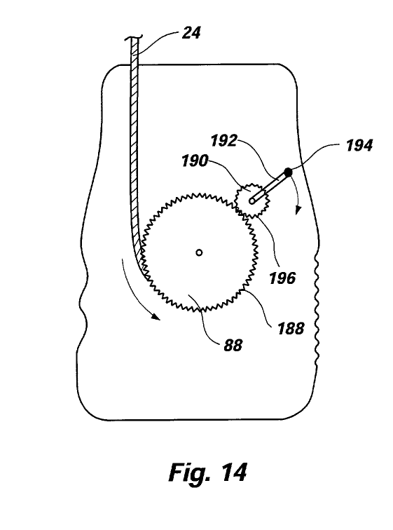

An alternative embodiment to the use of volute spring 104 for winding spool 88 is shown in FIG. 14. In the alternative embodiment, ratchet teeth 100 are replaced with gear teeth 188. Sprocket 190 is disposed proximate spool 88 and engages spool 88 through gear teeth 196. Lever 192 and handle 194 are attached to sprocket 190 for winding spool 88, for example, in the same fashion as a standard fishing reel. Hence, as handle 194 is reeled in the direction indicated, cable lock extension 24 is retracted into housing 12. This embodiment may prove desirable over other preferred embodiments when cable lock extension 24 is required to be relatively long as, for example, when multiple ski-like or snow-board-like items are to be secured with one lock and tool accessory 10.

Combination lock mechanism 26 secures distal end 28 to housing 12, thereby providing a continuous cable with which to secure one or more lockable items to a restraining structure or to render unuseable a ski-like or snow-board-like item, for example, ski 200. Combination lock mechanism 26 comprises a plurality of dial wheels 52 pivotally disposed on axial rod 132. Dial wheels 52 are secured in place on axial rod 132 by side walls 134 of cut-out portion 50. Dial wheels 52 control axial disposition of axial rod 132 between first axial position 138 and second axial position 140 (shown in phantom).

Axial rod 132 is slidably disposed through holes 56 and 168, which are formed by joining first portion 62 together with second portion 64, as illustrated in FIG. 4. Axial rod 132 has first axial position 138 and second axial position 140. In first axial position 138, step portion 142 of axial rod 132 is engaged with step portion 144 of head member 146, thereby securing head member 146 to housing 12. In second axial position 140, step portion 142 is disengaged from step portion 144 and head member 146 is free to retract from housing 12.

Spring means 148 biases axial rod 132 in first axial position 138. Axial rod 132 may be slidably urged into second axial position 140 by depressing cable lock release button 54, thereby freeing head member 146 for release from housing 12. Axial rod 132, however, is allowed to be slidably urged from first axial position 138 into second axial position 140 only when dial wheels 52 are set at the unlocking combination. Details regarding the construction and operation of combination lock mechanisms, in general, are known and are discussed, for example, in U.S. Pat. No. 5,156,028 (Jiang), the disclosure of which is incorporated herein by this reference. As such, these details are not discussed further herein.

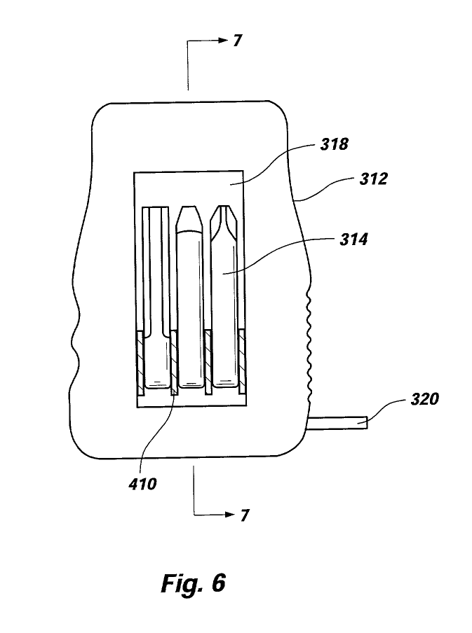

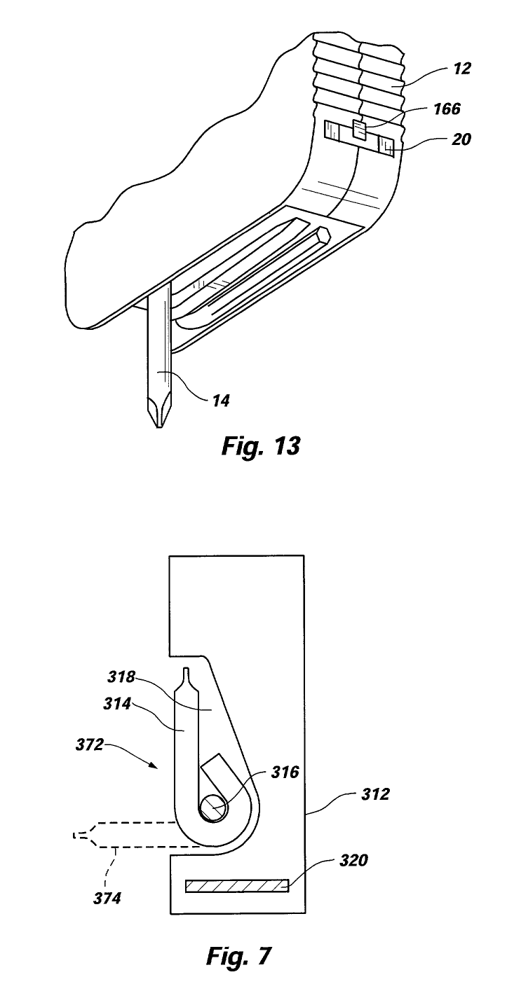

Various alternative embodiments concern the positioning of previously disclosed rotatable tools 14, shaft 16 and recess 18. FIGS. 6 and 7, for example, show rotatable tools 314 positioned in recess 318 which, alternatively, is located proximate first surface 338 of housing 312 rather than proximate second end 32 as previously disclosed. Positioning rotatable tools 314 in this fashion, which are rotatable between first position 372 and second position 374, allow the user to affect alternative torque and gripping characteristics.

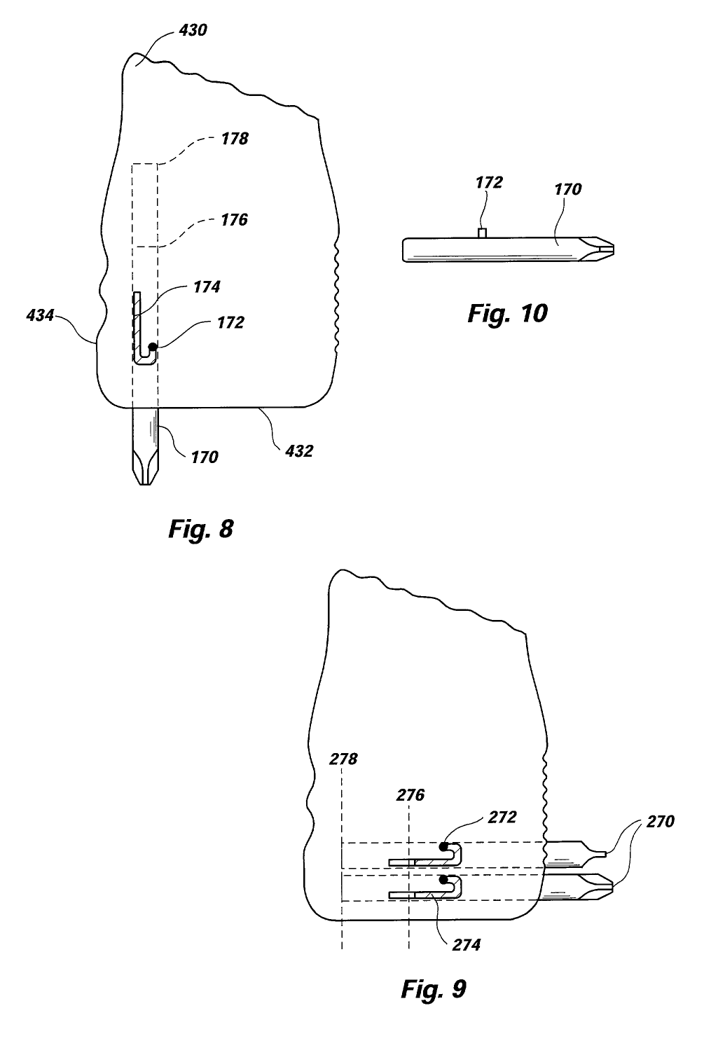

Various other alternative embodiments concern the incorporation of slidable tools 170 into lock and tool accessory 10. FIGS. 8 and 9, for example, illustrate two such embodiments. In FIG. 8, slidable tool 170 is shown in a second position 176 with slide member 172 locked in slide groove 174 for use. Slidable tool 170 may be retracted from second position 176 into first position 178 (shown in phantom) by sliding slide member 172, in sequnce, toward second end 432, sideways toward first sidewall 434, and then back toward first end 430. The lock and tool accessory may then be stored in the pocket of a user when slidable tool 170 is secured in first position 178. The embodiment illustrated in FIG. 9 is similar to that illustrated in FIG. 8 except that a plurality of slidable tools 270 are now shown mounted in a transverse fashion, rather than longitudinally, whereby said tools are operable between a first position 278 (shown in phantom) and a second position 276. FIG. 10 illustrates a side view of slidable tool 170 (270) with slide member 172 (272) attached thereon.

Various other alternative embodiments are illustrated in FIGS. 1 and 12. In FIG. 11, for example, removable tool 150 is shown secured within recess 182 through use of clips 180 secured to housing 512. Another example is shown in FIG. 12, whereby shaped tools 184 and 186 are formed integrally to housing 612.

Finally, various other modes for carrying out the invention are contemplated as being within the scope of the following claims particularly pointing out and distinctly claiming the subject matter which is regarded as the invention.

What is claimed is:

1. An accessory for positioning about any one or more of a ski, a pair of skis, a snow-board, a ski-like item or a snow-board-like item, to render the same essentially unuseable, said accessory comprising:
a housing having a first end and a second end, said second end being spaced from said first end, said housing being sized for gripping by the hand of a user;
locking means for securing said housing to any one or more of a ski, a pair of skis, a snow-board, a ski-like item or a snow-board-like item, said locking means having a lock mechanism positioned within said housing and a lock extension connected to said housing and configured for positioning about said any one or more of a ski, a pair of skis, a snow-board, a ski-like item or a snow-board-like item; and
tool means for operating a component attached to said any one or more of a ski, a pair of skis, a snow-board, a ski-like item or a snow-board-like item, said tool means being in mechanical association with said housing and positionable relative to said component for operating said component by manipulation of said tool means by said user.

2. The accessory of claim 1, wherein said housing has a first recess formed therein, wherein a shaft is positioned within said first recess and connected to said housing, and wherein said tool means includes rotatable tool means rotatably attached to said shaft, said rotatable tool means having an operable portion for engagement with said component.

3. The accessory of claim 2 wherein said rotatable tool means is configured to rotate between a first position in which said rotatable tool means is positioned within said recess and a second position in which the operable portion of said rotatable tool means is positioned outside of said recess.

4. The accessory of claim 3 wherein said tool means further includes removable tool means removably attached to said housing, said tool means having an operable portion for engagement with said component.

5. The accessory of claim 4 wherein said housing has a second recess formed therein and wherein said removable tool means is sized for positioning within said second recess and configured to operate between a first position in which said removable tool means is positioned within said recess and a second position in which the operable portion of said removable tool means is positioned without said recess.

6. The accessory of claim 5 wherein said lock mechanism is a combination lock mechanism and wherein said lock extension includes an extendable cable, said extendable cable having a proximal end secured within said housing, a distal end extendable from said housing, and a head member secured to said distal end for locking engagement with said combination lock mechanism.

7. The accessory of claim 6 wherein said extendable cable is windable on a spool rotatably mounted within said housing.

8. The accessory of claim 7 wherein said spool is connected to means for biasing said spool to retract said extendable cable into said housing, and wherein said spool is further connected to means for releaseably locking said spool from rotating.

9. The accessory of claim 5 wherein said lock mechanism is a key and tumbler lock mechanism and wherein said lock extension includes an extendable cable, said extendable cable having a proximal end secured within said housing, a distal end extendable outside of said housing, and a head member secured to said distal end for locking engagement with said combination lock mechanism.

10. A lock and tool assembly for securing items to a restraining structure, comprising:
a housing having a first end and a second end, said second end being spaced from said first end, said housing being sized for gripping by the hand of a user, and said housing having a first recess formed therein;
locking means for securing said housing to at least one unsecured item together with said restraining structure, said locking means having a lock mechanism positioned within said housing and a lock extension connected to said housing and configured for positioning about said at least one unsecured item together with said restraining structure; and
tool means for operating a component attached to said at least one unsecured item, said tool means being in mechanical association with said housing and positionable relative to said component for operating said component by manipulation of said tool means by said user, said tool means being sized for positioning within said first recess.

11. The assembly of claim 10 wherein said tool means includes rotatable tool means attached to said housing, said rotatable tool means having an operable portion for engagement with said component.

12. The assembly of claim 11 wherein said accessory further includes a shaft connected to said housing within said first recess and wherein said rotatable tool means is configured to rotate about said shaft.

13. The assembly of claim 12 wherein said tool means further includes removable tool means removably attached to said housing, said removable tool means having an operable portion for engagement with said component.

14. The assembly of claim 13 wherein said housing has a second recess formed therein and wherein said removable tool means is sized for positioning within said second recess and configured to operate between a first position in which said removable tool means is positioned within said recess and a second position in which the operable portion of said removable tool means extends outside of said recess.

15. The assembly of claim 14 wherein said lock mechanism is a combination lock mechanism and wherein said lock extension includes an extendable cable, said extendable cable having a proximal end secured within said housing, a distal end extendable from said housing, and a head member secured to said distal end for locking engagement with said combination lock mechanism.

16. The assembly of claim 15 wherein said extendable cable is windable on a spool rotatably mounted within said housing.

17. The assembly of claim 16 wherein said spool is connected to means for biasing said spool to retract said extendable cable into said housing, and wherein said spool is further connected to means for releaseably locking said spool from rotating.

18. The assembly of claim 14 wherein said lock mechanism is a key and tumbler lock mechanism and wherein said lock extension includes an extendable cable, said extendable cable having a proximal end secured within said housing, a distal end extendable from said housing, and a head member secured to said distal end for locking engagement with said combination lock mechanism.

19. An accessory for positioning about any one or more of a ski, a pair of skis, a snow-board, a ski-like item or a snow-board-like item, to render the same essentially unuseable, said accessory comprising:
a housing, said housing being sized for gripping by the hand of a user and having a first recess formed therein;
locking means for securing said housing to any one or more of a ski, a pair of skis, a snow-board, a ski-like item or a snow-board-like item, said locking means having a combination lock mechanism mounted within and to said housing and an extendable cable, said extendable cable having a proximal end secured to said housing, a distal end extendable from said housing, and a head member secured to said distal end for locking engagement with said combination lock mechanism, said extendable cable being configured for retractably positioning about said any one or more of a ski, a pair of skis, a snow-board, a ski-like item or a snow-board-like item;
first tool means for operating a first component attached to said any one or more of a ski, a pair of skis, a snow-board, a ski-like item or a snow-board-like item, said first tool means being removably connected to said housing and positionable relative to said component for operating said component by manipulation of said first tool means by said user, said first tool means being sized for positioning within said first recess;
a shaft connected to said housing; and
second tool means for operating a second component attached to said any one or more of a ski, a pair of skis, a snow-board, a ski-like item or a snow-board-like item, said second tool means being rotatably connected to said shaft.
